(19) United States
(12) Patent Application Publication
(10) Pub. No.: US 2022/0112587 A1
(43) Pub. Date: Apr. 14, 2022

(54) Iron Based Alloy

(71) Applicant: MONASH UNIVERSITY, Clayton (AU)

(72) Inventors: Kiyonori Suzuki, Clayton, Victoria (AU); Richard Parsons, Clayton, Victoria (AU); Ziyu Li, Clayton, Victoria (AU)

(21) Appl. No.: 17/422,111

(22) PCT Filed: Jan. 9, 2020
(86) PCT No.: PCT/AU2020/050011

§ 371 Date: Jul. 9, 2021

(30) Foreign Application Priority Data
Jan. 11, 2019 (AU) 2019900087

(51) Int. Cl. C22C 45/02; C22C 33/00

(52) U.S. Cl. CPC C22C 45/02; C22C 2200/02; C22C 33/003

(57) ABSTRACT

An alloy having formula (Fe₁₋ₓCoₓ)_{100-y-z-a}B_{y}Cu_{z}Mₐ, in which x=0.1-0.4, y=10-16, z=0-1, a=0-8, and M=Nb, Mo, Ta, W, Ni, or Sn, wherein the alloy has crystalline grains with an average size of 30 nm or less.

### FIELD OF THE INVENTION

The present invention relates generally to alloys and methods of making them, and specifically to Fe-based alloys and methods of making them.

### BACKGROUND OF THE INVENTION

Nanocrystalline Fe-based alloys can be provided with soft magnetic characteristics and are typically produced by the crystallization of rapidly quenched amorphous precursors. Those alloys possess a two-phase microstructure consisting of Fe-rich crystalline grains embedded within an amorphous matrix containing glass-forming elements.

Such materials possess soft magnetic characteristics that make them appealing in applications that require an enhancement and/or channeling of the magnetic flux produced by an electric current. For example, they may present an advantageously low coercivity (H_{c}), low or near zero saturation magnetostriction, and exceptionally low core losses. However, their large-scale production and application has been limited relative to, for example, conventional Fe—Si steel due to lower saturation magnetization (Jₛ) relative to that of Fe—Si steel (i.e. about 2T). This limits the specific power density of devices built using those alloys, making them unattractive for weight sensitive applications such as those found in the aerospace industry.

There has been a continuous drive in the recent years to develop alternative Fe-based alloy compositions that can replace conventional Fe—Si steel for soft magnetic applications. However, those alloys either do not possess sufficiently high Jₛ, or can only provide high Jₛ, at the expense of H_{c}, which remains undesirably high.

Accordingly, there remains an opportunity for the development of Fe-based alloys with improved soft magnetic characteristics over existing alloys.

### SUMMARY OF THE INVENTION

The present invention provides an alloy having formula (Fe₁₋ₓCoₓ)_{100-y-z-a}B_{y}Cu_{z}Mₐ, in which x=0.1-0.4, y=10-16, z=0-1, a=0-8, and M=Nb, Mo, Ta, W, Ni, or Sn, wherein the alloy has crystalline grains with an average size of 30 nm or less.

The specific composition and microstructure of the alloys of the invention surprisingly confer them an advantageous combination of high magnetic saturation (Jₛ) and low magnetic coercivity (H_{c}) relative to conventional alloy compositions.

As used herein, and as it would be known to a skilled person, the expression “magnetic saturation” indicates the magnetic state reached by the alloy when an increase in an applied external magnetic field cannot increase the magnetization of the material further. The expression “magnetic coercivity” is also used herein according to its conventional meaning, i.e. that of a measure of the ability of the alloy to withstand an external magnetic field without becoming demagnetized.

Advantageously, the alloys of the invention can combine high Jₛ values (e.g. higher than 1.98 T) and low H_{c} (e.g. below 25 A/m, for example below 10 A/m). In some embodiments, the alloy presents a Jₛ higher than 2T. Typically, values of H_{c} below 25 A/m are highly desirable for commercial applications. This makes the alloys of the invention appealing to replace conventional Fe—Si steel for soft magnetic applications. The alloy of the present invention can therefore function as a soft magnetic alloy and is particularly suitable for use as in applications that require an enhancement and/or channelling of the magnetic flux produced by an electric current.

By functioning as a “soft magnetic” alloy, the alloy of the invention is susceptible to magnetic fields, however the ferromagnetic nature of the alloy only appears after an external magnetic field is applied. The alloy of the invention can therefore be considered a soft magnetic alloy. In other words, the invention may also be said to provide a soft magnetic alloy having formula (Fe₁₋ₓCoₓ)_{100-y-z-a}B_{y}Cu_{z}Mₐ, in which x=0.1-0.4, y=10-16, z=0-1, a=0-8, and M=Nb, Mo, Ta, W, Ni, or Sn, wherein the alloy has crystalline grains with an average size of 30 nm or less.

The present invention also provides a method of making an alloy, the method comprising (i) preparing an amorphous alloy having formula (Fe₁₋ₓCoₓ)_{100-y-z-a}B_{y}Cu_{z}Mₐ, in which x=0.1-0.4, y=10-16, z=0-1, a=0-8, and M=Nb, Mo, Ta, W, Ni, or Sn, and (ii) heating the amorphous alloy at a heating rate of at least 200° C./s.

By heating an alloy composition as described herein with a heating rate of at least 200° C./s, the method of the invention can advantageously enable the manufacture of alloys that combine high Jₛ without significantly compromising its soft magnetic properties (i.e. H_{c}). The method of the present invention is particularly advantageous over conventional methods in that it enables the synthesis of alloys with high content of Co (providing for high Jₛ), yet possessing coercivity levels that are significantly lower than those conventionally associated with alloys having Co content above 8% (atomic).

Further aspects and/or embodiments of the invention are outlined below.

### BRIEF DESCRIPTION OF THE DRAWINGS

Embodiments of the invention will be now described with reference to the following non-limiting drawings, in which:

FIG. 1 shows (a) a schematic of the temperature evolution of an alloy during heating, and (b) magnetic hysteresis curves measured on embodiment (Fe_{0.8}Co_{0.2})₈₇B₁₃ alloys obtained with rapid transverse field annealing (TFA) and no-field annealing (NFA),

FIG. 2 shows examples of annealing configurations using pre-heated (a) blocks or (b) rolls in accordance to embodiment procedures,

FIG. 3 shows core losses measured on embodiment (Fe_{0.8}Co_{0.2})₈₇B₁₃ alloys obtained with rapid transverse field annealing (TFA) and no-field annealing (NFA),

FIG. 4 shows X-Ray Diffraction (XRD) patterns acquired from (a) as-cast (Fe₁₋ₓCoₓ)₈₇B₁₃ and (b) after annealing,

FIG. 5 shows direct current (DC) coercivity (H_{c}), mean grain size (D) and saturation magnetic polarization (Jₛ) with respect to heating rate for (Fe_{0.75}Co_{0.25})₈₇B₁₃,

FIG. 6 shows DC coercivity and with respect to annealing temperature for (Fe₁₋ₓCoₓ)₈₇B₁₃,

FIG. 7 shows DC coercivity (H_{c}), mean grain size (D) and saturation magnetic polarization (Jₛ) with respect to Co content for (Fe₁₋ₓCoₓ)₈₇B₁₃,

FIG. 8 shows XRD patterns of (a) as-cast (Fe_{0.8}Co_{0.2})_{87-z}B₁₃Cu_{z} samples with z=0, 0.5, 1 and, for comparison, z=1.5, and (b) annealed (Fe₁₋ₓCoₓ)₈₆B₁₃Cu₁ samples with x=0 to 0.3,

FIG. 9 shows DC coercivity with respect to the annealing temperature for (Fe_{0.8}Co_{0.2})_{87-z}B₁₃Cu_{z} samples with z=0, 0.5, 1 and, for comparison, z=1.5,

FIG. 10 shows DC coercivity (H_{c}), mean grain size (D) and saturation magnetic polarization (Jₛ) with respect to Cu content for (Fe_{0.8}Co_{0.2})_{87-z}B₁₃Cu_{z} samples with z=0, 0.5, 1 and, for comparison, z=1.5,

FIG. 11 shows DC B-H hysteresis curves and listed grain sizes for (Fe_{0.5}Co_{0.5})₈₇B₁₃ after ultra-rapidly annealing at 460° C. (733 K) to 540° C. (813 K) for 0.5 s,

FIG. 12 shows the relationship between coercivity and the mean grain size for (Fe₁₋ₓCOₓ)₈₇B₁₃, (Fe_{0.8}Co_{0.2})_{87-z}B₁₃Cu_{z} and (Fe₁₋ₓCoₓ)₈₆B₁₃Cu₁ annealed at a heating rate of 10,000° C./s along with (Fe_{0.75}Co_{0.25})₈₇B₁₃ annealed at heating rates ranging from 3.7 to 10,000° C./s,

FIG. 13 shows Jₛ with respect to Co content, x, for as-cast and annealed (Fe₁₋ₓCoₓ)₈₇B₁₃ annealed (Fe₁₋ₓCoₓ)₈₆B₁₃Cu₁, and crystalline Fe₁₋ₓCoₓ,

FIG. 14 shows the complex magnetic permeability with respect to applied magnetic field acquired at 1000 Hz (frequency of the field used during measurement) for a transverse field annealed (TFA) sample, a longitudinal field annealed (LFA) sample and a sample annealed without the application of an external applied field (NFA),

FIG. 15 shows the coercivity for a (Fe_{0.8}Co_{0.2})₈₇B₁₃ embodiment alloy in function of annealing temperature,

FIG. 16 shows DC hysterics loop measured on a (Fe_{0.8}Co_{0.2})₈₇B₁₃ embodiment alloy after annealing at an optimum annealing temperature,

FIG. 17 shows the effect of annealing and cooling on the magnetic polarization characteristics of a (Fe_{0.8}Co_{0.2})₈₇B₁₃ embodiment alloy, obtained by annealing in the presence of a transverse magnetic field followed by cooling in the presence/absence of the magnetic field, and

FIG. 18 shows core loss at 50, 400 and 1000 Hz measured on a 3 wt % iron-silicon steel comparative sample relative to that of a (Fe_{0.8}Co_{0.2})₈₆B₁₃Cu₁ embodiment alloy.

### DETAILED DESCRIPTION OF THE INVENTION

The present invention provides an alloy having formula (Fe₁₋ₓCoₓ)_{100-y-z-a}B_{y}Cu_{z}Mₐ in which x=0.1-0.4, y=10-16, z=0-1, a=0-8, and M=Nb, Mo, Ta, W, Ni, or Sn. Unless otherwise stated, the elemental ranges and compositional values used herein are intended to refer to atomic percentages.

Because of its specific composition, the alloy of the invention has a two-phase microstructure characterized by a crystalline phase made of body centred cubic (bcc) Fe—Co crystalline grains or, when Ni is present, bcc Fe—Co—Ni crystalline grains embedded within an amorphous phase. The amorphous phase contains a high concentration of non-ferromagnetic elements such as B, Cu, Nb, Mo, Ta, W and Sn, when present in accordance with the definition of the formula.

By x falling in the range of from about 0.1 to about 0.4, the alloy of the invention has enough cobalt to advantageously provide a magnetic saturation Jₛ of above 1.98 T. Such values of Jₛ make the alloy of the invention competitive against conventional soft magnetic alloys based on, for example Fe—Si steel. It has also been observed that when x is below 0.1 and above 0.4, the Jₛ of the alloy fall below 1.98 T, making the alloy less attractive for practical purposes. In some embodiments, the alloy advantageously has a magnetic saturation of at least 2 T.

In some embodiments, x is in the range of from about 0.2 to about 0.3. In those embodiments, the alloy contains enough cobalt to ensure a Jₛ of at least 2 T.

The alloy of the invention comprises boron at an atomic content in the range of from about 10% to about 16% (i.e. y=10-16). That range ensures stability of the amorphous phase and presence of minimal amounts of hard magnetic Fe—B compounds, which can contribute to an increase of the H_{c} due to their large magnetocrystalline anisotropy. Specifically, at least 10% boron in the alloy enhances the stability of the amorphous phase, while less than 16% boron minimises the presence of unwanted Fe—B compounds after heating.

In some embodiments, y is at least 11. For example, y may be at least 12. In those embodiments the glass formability of the amorphous phase upon casting is improved (i.e. the manufacture of an amorphous phase without the inclusion of a crystalline phase is improved).

In some embodiments y is at least 15% or less, for example 14% or less. Those concentrations advantageously ensure absence of unwanted Fe—B compounds in the alloy and improve the magnetic saturation of the alloy (i.e. the magnetic saturation increase as y is decreased).

The alloy may also comprise copper. Specifically, the alloy of the invention comprises copper in an atomic concentration of 0-1% (i.e. z=0-1). Copper in the alloy composition can contribute to the refinement of the grains that constitute the crystalline phase of the alloy. This can be advantageous for example during synthesis of the alloy since the copper is thought to provide heterogeneous nucleation sites for the crystalline phase. Even at low concentrations of copper (e.g. z=0.2, or z=0.5) grain refinement of the crystalline phase has been observed. On the other hand, excessive amounts of copper (e.g. above 1%) can prevent the formation of an amorphous phase in the first place, causing the alloy to become too brittle for use in practical applications and with poor magnetic softness. Accordingly, in some embodiments z is in the range of 0.2-1, 0.2-0.7, or 0.2-0.5.

The alloy of the invention may also comprise an element M selected from Nb, Mo, Ta, W, Ni, and Sn. Specifically, the alloy comprises 0 to 8% atomic content of Nb, Mo, Ta, W, Ni, or Sn (i.e. a=0-8). Presence of element M is advantageous to minimise the H_{c} of the alloy. For example, any one of those elements during synthesis of the alloy can inhibit grain growth of the crystalline phase, resulting in an alloy with reduced H_{c}. In addition, presence of element M can ensures further stabilisation of the amorphous phase over a wider range of temperatures relative to the alloy absent M. On the other hand, excess content of element M in the alloy above 8% may be detrimental to the Jₛ of the alloy due to the corresponding decrease in Fe and Co content in the alloy.

Accordingly, in some embodiments a is in the range of 0-7.5, 0-5, 0-2.5, or 0-1.

In some embodiments, z and a are both 0.

The alloy of the invention has crystalline grains with an average size of 30 nm or less. For a given alloy, the “average size” of its crystalline grains is the average grain size determined from the X-ray diffraction (XRD) pattern of the alloy by the Scherrer's equation, with reference to the line broadening of the Fe (110)_{bcc} reflection according to a procedure that would be known to a skilled person.

XRD patterns measured on embodiment alloys show that the crystalline grains have a body centred cubic (bcc) crystal structure. Without wanting to be confined by theory, it is believed the grains have a composition equal to approximately Fe₁₋ₓCoₓ, where x is the nominal composition. Elements B, Cu (when present), Nb (when present), Mo (when present), Ta (when present), W (when present), and Sn (when present), are generally considered to be excluded into the residual amorphous phase during crystallisation and so are not believed to be included in the crystalline grains. The only exception is for Ni, when present. Therefore, for Ni-containing alloys it is believed that the crystalline grains contain Fe, Co and Ni in the same fractions as expressed in the nominal composition.

The crystalline grains may be of any average size below 30 nm. In some embodiments, the alloy comprises crystalline grans having an average size of about 20 nm or less, about 15 nm or less, about 10 nm or less, or about 5 nm or less. For example, the alloy may comprise crystalline grans having an average size of from about 10 to about 30 nm.

By the specific combination of cobalt content (x=0.1-0.4) and grain size of less than 30 nm, the alloy of the invention is advantageously characterised by a magnetic saturation Jₛ of above 1.98 T while maintaining a coercivity of less than 25 A/m, for example less than 10 A/m. This is surprising in view of the conventional understanding that alloys having cobalt content above 8 at % may provide for high Jₛ, but inevitably suffer from high H_{c} due to magnetically induced anisotropy.

Without wanting to be confined by theory, it is believed that the crystalline phase of the alloy of the invention is advantageously characterised by low values of magnetization induced anisotropy associated with cobalt. This allows for the alloy of the invention to contain higher content of cobalt while maintaining a high magnetic softness relative to conventional Fe—Co alloys, which translates in alloys with Jₛ of at least 1.98 T and H_{c} of about 25 A/m or less, for example about 10 A/m or less.

It is believed that the specific microstructure of the alloys of the invention provide for overall randomised magneto-crystalline anisotropy, which acts to average out the local magneto-crystalline anisotropy of the crystalline grains. Specifically, while each grain may possess a well-defined magnetic axis, the randomised spatial orientation of all the grains may be such that the resulting magnetic anisotropy of the alloy as a whole is minimal. As a result, the effect of a large intrinsic magneto-crystalline anisotropy on the coercivity can be minimized. The effectiveness of this averaging processing is diminished by the presence of a coherent magnetization induced anisotropy in the alloy. In principle, the extent of magnetization induced anisotropy can be quantified with reference to specific parameters, a useful one of which being the coefficient of uniaxial anisotropy (Kᵤ) of the overall alloy. As a skilled person would know, such parameter provides a measurement of the directional dependence of the alloy's magnetic properties.

In this context, the anisotropy coefficient associated with the alloy of the invention can be significantly lower relative to that of conventional soft magnetic alloys. For example, the alloy of the invention may have a coefficient of uniaxial anisotropy (Kᵤ) of less than about 200 J/m³. In some embodiments, the alloy has an anisotropy coefficient (Kᵤ) of less than about 100 J/m³, less than about 50 J/m³, less than about 25 J/m³, or less than about 10 J/m³.

As a skilled person will appreciate, the alloy of the invention may also contain unavoidable impurities. As used herein, the expression “unavoidable impurity” refers to an element other than those of the alloy of the invention that is inevitably present in the alloy as a result of the specific synthesis of the alloy, for example because inherently present in the alloy precursors. Examples of such impurities include S, O, Si, Al, C and N.

The present invention also provides a method of making an alloy, which includes the preparation of an amorphous alloy having formula (Fe₁₋ₓCoₓ)_{100-y-z-a}B_{y}Cu_{z}Ma, in which x=0.1-0.4, y=10-16, z=0-1, a=0-8, and M=Nb, Mo, Ta, W, Ni, or Sn. By the alloy being “amorphous” is meant that at least 80% in volume of the alloy is in a non-crystalline state.

The amorphous alloy may be prepared by any procedure known to a skilled person that would result in an amorphous alloy having the specified composition. For example, the amorphous alloy may be produced by quenching an alloy melt.

In a typical procedure, an alloy melt would be first synthesised. For example, an alloy melt may be produced by melting constituting elements of the alloy (herein also referred to as “alloy precursors”). The alloy precursors may be melted individually and subsequently mixed to form the alloy melt. Alternatively, at least one of the alloy precursors is melted (typically the main element of the alloy) and the other element(s) added to it to dissolve completely in it. As a further alternative solid alloy precursors (for example in particulate, powder, or ingot form) are first combined and the combination heated to a temperature that is sufficiently high to melt the elements and blend the molten elements to generate the alloy melt. The alloy precursors are heated to a melting temperature sufficient to liquefy them in their entirety. Examples of suitable melting temperatures include 50° C., 100° C., or 300° C. (or more) above the temperature at which the alloy precursors are liquid. Although there are no particular limitations on the atmosphere when discharging the melt, the atmosphere is preferably that of an inert gas and the like from the viewpoint of reducing contamination of the amorphous alloy by oxides and the like.

The alloy melt may then be held at the melting temperature for sufficient time to ensure homogenisation of the alloy melt. Accordingly, the actual melt temperature and time at the melt state may be any temperature and time that ensure complete homogenisation of the alloy precursors. In some embodiments, the alloy melt is heated and held at a temperature of about 300° C.-2,000° C. for at least 10 minutes to allow for homogenisation.

In some embodiments, one or more of the alloy precursors are heated separately. For example, each alloy precursor may be liquefied or partially liquefied before they are mixed together to form the alloy melt. In yet more embodiments, one or more of the alloy precursors are heated to different temperatures before they are mixed.

The alloy precursors may be heated to provide the alloy melt according to any suitable procedure known to the skilled person. For example, the alloy melt may be prepared by resistance melting, arc-melting, induction melting, or a combination thereof. In resistance melting, an electrical resistance is used as source of heat. In the case of arc-melting, heating is achieved by means of an electric arc which is used as a source of heat. In the case of induction heating, heating is performed by electromagnetic induction through heat generated in the object by eddy currents at high frequency.

The alloy melt may then be quenched in accordance with any procedure that ensures formation of an amorphous alloy. For example, the cooling of the alloy melt may be performed by melt spinning, centrifugal spinning, or solution quenching, under a cooling rate that is sufficiently high to ensure formation of an amorphous alloy.

In some embodiments, the amorphous alloy is produced by melt spinning, for example in a planar flow casting procedure by dropping the alloy melt onto a rotating cooling roll. The procedure may be conducted in inert conditions, for example under argon. The cooling roll may be rotating at any rotation rate conducive to quenching the alloy melt to produce an amorphous alloy. For example, the cooling roll may rotate at a peripheral velocity of about 15 m/s or more, about 30 m/s or more, or about 40 m/s or more. In some embodiments, the cooling roll rotates at a peripheral velocity of 55 m/s or less, 70 m/s or less or 80 m/s or less. A skilled person would be capable to devise suitable rotation rates conducive to quenching the alloy melt to produce an amorphous alloy.

Depending on the quenching procedure, the amorphous alloy may be provided in the form of a ribbon, a flake, granules, or bulk. For example, when the amorphous alloy is produced by melt spinning the alloy is provided in the form of a ribbon. The ribbon may have dimensions that depending on the melting and spinning conditions. The ribbon may have a thickness in the range of from about 5 μm to about 45 μm, for example from about 10 μm to about 15 μm. The ribbon may also have a width in the range of from about 0.5 mm to about 220 mm, for example from about 1 mm to about 200 mm, from about 1 mm to about 150 mm, from about 1 mm to about 100 mm, from about 1 mm to about 50 mm, from about 1 mm to about 25 mm, or from about 1 mm to about 12 mm.

Certain elements in the composition of the alloy can play a role in determining the microstructure and composition of the alloy during quenching of the melt. For instance, presence of at least 10% at of B (boron) in the alloy composition (y≥10) facilitates the formation of the alloy in amorphous form and assists with the stability of the amorphous phase. At the same time, 16% boron or less (y≤16) minimises the formation of unwanted hard magnetic Fe—B compounds during annealing, as explained herein. Also, Fe—B compound formation upon crystallization of the amorphous phase can be avoided when the content of B in the amorphous alloy is 16 at % or less.

Accordingly, in some embodiments y is at least 11. For example, y may be at least 12. In some embodiments y is at least 15% or less, for example 14% or less. Those concentrations advantageously ensure absence of unwanted Fe—B compounds in the alloy.

The method of the invention also requires that the amorphous alloy be then heated at a heating rate of at least 200° C./s. In the context of the invention, the “heating rate” will be understood to be rate at which a given amorphous alloy is heated as measured by an uninsulated K-type thermocouple with a tip diameter of 0.1 mm that is in intimate thermal contact with the alloy.

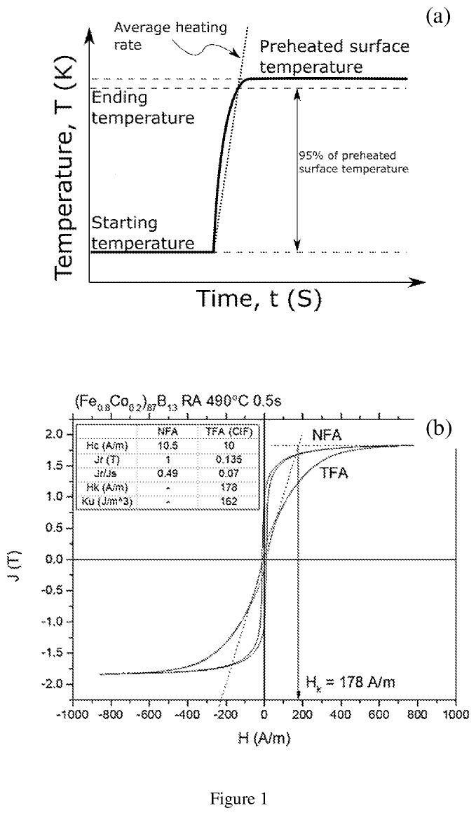

In a typical procedure, the heating rate may be determined in relation to the temperature rise measured with reference to a starting temperature and an ending temperature in a single-step process. The starting temperature may be room temperature (e.g. about 22° C.), and the ending temperature may be a value that is 95% of the difference between the starting temperature and the temperature of the preheated surfaces used for the annealing process. A schematic of the temperature profile associated with this type of determination is shown in FIG. 1(a), together with a representation of the relevant reference parameters. In the example procedure, the thermocouple tip is rapidly (i.e. less than 0.1 seconds) brought into contact with two parallel preheated surfaces with enough force to ensure good contact (i.e. thermocouple surface pressure of ˜1 GPa). The temperature of the preheated surfaces is measured by a secondary thermocouple imbedded within the heating surfaces no more than 1 mm from the contact region and after the temperature reading has stabilised for a period of no less than 10 seconds so as to provide an accurate representation of the surface temperature. The mass of the heating surfaces should be large enough that their measured temperature changes by no greater than 5° C./s during the entirety of the annealing process.

By annealing the amorphous alloy at a heating rate of at least 200° C./s, it is possible to promote formation of a fine crystalline phase made of bcc Fe—Co or, when included, Fe—Co—Ni, embedded within an amorphous phase, in which the average size of the crystalline grains is advantageously below 30 nm. In general, the higher the heating rate, the smaller the average size of crystalline grains. As a result, higher heating rates advantageously provide for alloys characterised by reduced values of H_{c}. In particular, it has been found that a heating rate of at least 200° C./s advantageously provide precise control on the alloy microstructure (i.e. crystalline grains below 30 nm in size) leading to significant reduction of H_{c} of 25 A/m or less, while ensuring high Jₛ (i.e. above 1.98 T).

In this context, it will therefore be understood that higher heating rates are beneficial to reduce the overall magnetization induced anisotropy of the alloy, which is conducive to lower values of H_{c} as explained herein. The method of the present invention is therefore advantageous in that it allows to control and minimize magnetically induced anisotropy during annealing, thereby enabling the synthesis of Fe—Co alloys having high Co content (and therefore high Jₛ) without compromising H_{c}.

Accordingly, in some embodiments the heating rate is higher than 200° C./s. For example, the amorphous alloy may be heated at a heating rate of at least about 250° C./s, at least about 500° C./s, at least about 750° C./s, at least about 1,000° C./s, at least about 1,500° C./s, at least about 2,000° C./s, at least about 5,000° C./s, at least about 7,500° C./s, at least about 10,000° C./s, or at least about 15,000° C./s.

It will be understood that provided the method comprises heating the amorphous alloy at a heating rate of at least 200° C./s, the heating procedure may be made entirely of a heating step at that rate, or the heating at that rate may be conducted as part of a multi-step heating procedure. In any case, the rapid heating rate is performed during the majority (i.e. more than 50%) of the crystallisation process.

Any annealing procedure that enables heating of the amorphous alloy at a rate disclosed herein would be suitable for use in the method of the invention.

For example, the amorphous alloy may be contacted to heating elements that have been pre-heated at high temperature. In that regard, the heating elements may be pre-heated to any temperature that will result in the amorphous alloy heating at a heating rate of at least 200° C./s as the amorphous alloy comes into thermal contact with the heating elements. For example, the heating elements may be pre-heated at least at about 500° C., at least about 750° C., or at least about 1,000° C. In some embodiments, the heating elements are pre-heated at about 500° C.

Contacting the amorphous alloy to heating elements that have been pre-heated as described herein may be achieved by any means known to a skilled person that would be suitable for the intended purpose.

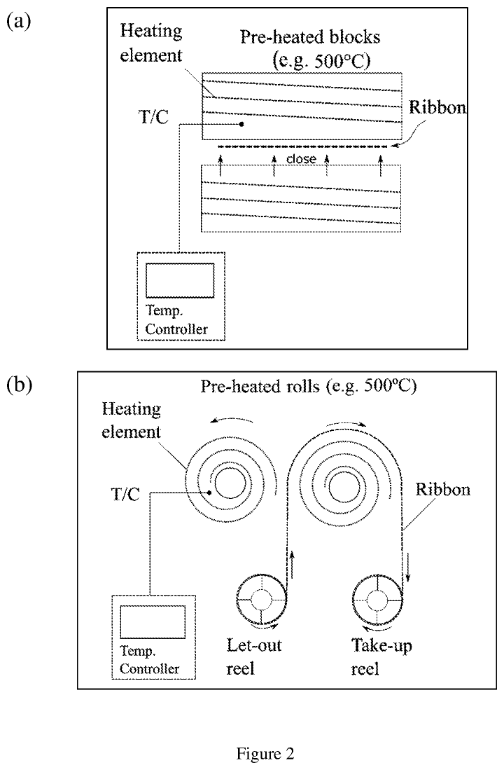

For example, the amorphous alloy may be contacted to pre-heated heating elements in the form of heating blocks. This may be achieved, for instance, by an apparatus that allows clamping the amorphous alloy between pre-heated blocks. The blocks may be made of any material that can be pre-heated to the desired heating temperature and ensures fast heat transfer to the alloy. Examples of suitable block materials may therefore include a metal (e.g. copper, titanium), an alloy (e.g. steel, aluminium alloy), and a ceramic material (e.g. alumina). The clamping may be effected by applying a clamping force that ensures homogeneous distribution of heat across the alloy. In some embodiments, heating of the amorphous alloy is performed by clamping the alloy between pre-heated blocks with a pressure of at least about 3 kPa, for example at least 30 kPa, or at least 100 kPa. In an embodiment, the clamping force is 133 kPa. An example of one such configuration is shown in FIG. 2(a), in which a ribbon of amorphous alloy is clamped between pre-heated heating bocks.

According to alternative configurations, the amorphous alloy may be contacted to heating elements in a hot rolling configuration. Those configurations are particularly attractive in that they enable continuous annealing of the amorphous alloy. In those instances, the heating elements may be in the form of two rolls pre-heated at the desired temperature and in contact to one another such that to a rotation of one roll corresponds a counter-rotation of the other roll. According to such arrangement, the amorphous alloy in the form of a ribbon would pass between the rotating rolls. Each roll may be made of any material that can be pre-heated to the desired heating temperature and ensure fast heat transfer to the alloy. Examples of suitable materials in that regard may therefore include a metal (e.g. copper, titanium), an alloy (e.g. steel, aluminium alloy), and a ceramic material (e.g. alumina). The rolls may be pressed against each other to achieve a clamping pressure of at least about 3 kPa, for example at least 30 kPa, or at least 100 kPa. In an embodiment, the rolls are pressed against each other to achieve a clamping force of 133 kPa.

An example of a hot rolling configuration suitable for use in the invention is shown in FIG. 2(b). The Figure shows a configuration based on a pair of pre-heated rollers through which a ribbon of the amorphous alloy is made to pass. The rollers are pre-heated to any suitable temperature described herein, and the temperature of each roll may be adjusted independently to achieve the desired alloy structure. As the rolls rotate, the amorphous alloy ribbon is drawn from a let-out reel and passes between the rolls, which may be pressed against each other at a pressure of the kind described herein. In the depicted configuration, the ribbon is made to contact one of the rolls tangentially along half the roll's circumference. However, the extent of contact between the ribbon and the roll may be varied to achieve the desired extent of heating of the ribbon. As the ribbon leaves the point of contact between the rolls, its temperature has been raised to a level high enough for crystallisation to begin. By remaining in contact with one of the rolls as the roll rotates, the exothermic heat produced during crystallisation can be removed. The ribbon then leaves the roll surface and is cooled (by either natural convection, forced convection, chilled blocks or a liquid cooling bath) before being taken up by a take-up reel. In certain configurations, a servomotor may be attached to one of the rolls to impart rotation at a controlled velocity. The rotation speed may be modulated to control the annealing time of the ribbon. Also, servomotors attached to the let-out and take-up reels may be used to supply a constant torque, and therefore tension, on the ribbon. In addition, encoders attached to the servomotors would be able to monitor, and record, the difference in the total number of rotations of the two mandrels allowing for an estimation and control of the tensile strain applied to the ribbon during the annealing process In those instances, it is particularly advantageous to produce alloy ribbons with minimal thickness, typically below 18 μm. This would ensure that undesirable eddy current formation is limited when a ribbon is formed into a laminated core and exposed to an alternating magnetic field. As a result, the alloy production system can be designed to have higher efficiency (i.e. lower power loss) servomotors, with consequent economic benefits.

Further annealing procedures that may be suitable for achieving a heating rate of at least 200° C./s include liquid bath annealing and hot air annealing.

In liquid bath annealing, the amorphous alloy is dipped into a liquid bath held at a high temperature. The bath functions as heating element, and may be held at a pre-heating temperature of the kind described herein. The amorphous alloy may be immersed for any duration of time suitable to achieve the desired structure (e.g., units of seconds to minutes, for instance from 0.5 to 5 seconds). The bath may be made of any material that would be in a molten state at the required bath temperature. Examples of suitable materials in that regard include molten Pb—Sn-based solder, molten gallium, molten aluminium-gallium alloy, and molten salts.

In the case of hot air annealing, the amorphous alloy (for example in the form of a ribbon) is rapidly heated by passing it over a stream of high temperature air, which functions as heating element. In some configurations, the alloy may be in the form of a ribbon that is drawn from a first spool and taken up by a second spool. In those instances, controlling the torque and/or speed of the spools (for example by servomotors) allows to modulate the tension of the ribbon during annealing.

Irrespective of how the amorphous alloy is heated, control over the actual heating rate of the amorphous alloy may be achieved by interposing between the heating element and the amorphous alloy sample one or more insulating layers. Such layers may be made, for example, of a material having the same or lower thermal conductivity than the material of the heating element. For example, control over the heating rate may be achieved by interposing between the heating element and the amorphous alloy sample one or more layer(s) of a metal (e.g. iron, titanium), an alloy (e.g. steel, aluminium alloy), or a ceramic material (e.g. alumina).

In the method of the invention the amorphous alloy may be heated at any annealing temperature that is suitable to provide an alloy having microstructure characterised by a crystalline phase made of mainly bcc Fe crystalline grains containing Co and, when present, Ni embedded within an amorphous phase. Without wanting to be confined by theory, it is believed that during heating the microstructure of the amorphous alloy evolves in accordance with a two-stage crystallisation mechanism in accordance with the sequence (amorphous)→(bcc Fe also containing Co or Ni, when present))+(amorphous phase)→(bcc Fe also containing Co or Ni, when present)+(hard magnetic compounds, such as Fe—B).

Accordingly, the determination of an appropriate annealing temperature in relation to a given heating rate may be made to ensure minimal or no formation of hard magnetic compounds, i.e. to ensure minimum coercivity. In general, the crystalline phase will form when the annealing temperature is equal to or higher than the crystallization onset temperature. In that regard, strong magneto-crystalline anisotropy associated with the formation of hard magnetic Fe—B compounds may be induced when the annealing temperature exceeds the crystallization onset temperature of Fe—B compounds. Thus, one may determine the annealing temperature to be one that does not reach or exceed the crystallization onset temperature of Fe—B compounds. For example, the annealing temperature of the amorphous alloy may be just lower (e.g. 5-20° C. lower) than the temperature at which Fe—B compounds start to form.

Accordingly, in some embodiments the annealing temperature is in the range of from about 350° C. to about 650° C., from about 400° C. to about 650° C., from about 450° C. to about 600° C., from about 450° C. to about 550° C., or from about 450° C. to about 500° C. For example, the annealing temperature may be about 490° C., about 500° C., about 510° C., or about 520° C.

One or more other factors may need to be taken into account when selecting a suitable annealing temperature for the purpose of the invention. For example, crystallisation reactions associated with the formation of crystalline phase in the alloy may be accompanied by the release of significant latent heat, which itself may contribute to the heating of the alloy. In that regard, a skilled person will take such additional contribution into consideration when devising the heating procedure. For example, the skilled person may adopt suitable precautions for the suppression or removal of excess latent heat of crystallisation during annealing (e.g. the use of a preheated surface with a suitable mass and thermal conductivity such that it would allow for the latent heat to be removed during the formation of a crystalline phase).

In the method of the invention the amorphous alloy may be maintained at a given annealing temperature for as long as it is necessary to provide an alloy having microstructure characterised by a crystalline phase made of mainly bcc Fe containing Co and, when present, Ni crystalline grains embedded within an amorphous phase. Suitable annealing times include, for example, from about 0 seconds to about 80 seconds, from about 0.1 seconds to about 80 seconds, from about 0.1 seconds to about 60 seconds, from about 0.1 seconds to about 30 seconds, from about 0.1 seconds to about 15 seconds, from about 0.1 seconds to about 10 seconds, from about 0.1 seconds to about 5 seconds, from about 0.1 seconds to about 1 seconds, or from about 0.1 seconds to about 0.5 seconds.

In some embodiments, while being heated the amorphous alloy is also subjected to an external force, for example a tensile stress and/or a compressive stress. The application of a tensile stress and/or a compressive stress during annealing induces elastic strain in the structure of crystals that form during annealing. This assists with control over the directionality of magnetization-induced anisotropies forming during annealing of the alloy.

Subjecting the amorphous alloy to a tensile stress and/or a compressive stress during heating may be achieved by any means known to the skilled person. For instance, when heating is performed by placing the amorphous alloy between heating elements such that the alloy is in thermal contact with the elements, the heating elements may be pressed against each other to apply a compressive stress to the alloy. In addition, or alternatively, the amorphous alloy may be subjected to a tensile stress by having the alloy pulled at opposing ends while being in contact with the heating elements. This may be achieved by any means known to a skilled person. For example, the alloy may be clamped at opposing ends and mechanically pulled. Alternatively, if the heating elements are in the form of heating rolls, the tension of the alloy may be modulated as described herein.

In some embodiments, the heating of the amorphous alloy comprises exposing the alloy to a magnetic field. This provides additional control over the directionality of magnetization induced anisotropies forming during annealing of the alloy. In particular, by exposing the alloy to a magnetic field during annealing it is possible to maximize the effectiveness of randomization of magneto-crystalline anisotropy, which assists with averaging out the local magneto-crystalline anisotropy of the crystalline grains during their formation. As a result, the H_{c} of the resulting alloy can be further minimized.

The magnetic field may be of any intensity that would be suitable to align the magnetization of the material during the formation of crystalline grains and/or during the cooling process after the completion of annealing. In some embodiments, the magnetic field has an intensity of at least about 0.3 kA/m. For example, the magnetic field may have an intensity of at least about 1 kA/m, at least about 3 kA/m, at least about 10 kA/m, at least about 30 kA/m, or from at least about 300 kA/m. In some embodiments, the magnetic field has an intensity of about 1000 kA/m.

In some embodiments, the magnetic field is rotating, or otherwise changing its orientation and/or magnitude, with respect to the alloy material. By adopting a magnetic field that is rotating, or otherwise changing its orientation and/or magnitude, with respect to the alloy material it is possible to obtain an alloy having essentially isotropic magnetization distribution. This can dramatically improve the soft magnetic properties (i.e. lower H_{c}) of the alloy due to the significant suppression of magnetically induced anisotropy.

Any means that would enable the annealing of the amorphous alloy in the presence of a magnetic field which is changing its orientation and/or with respect to the alloy material would be suitable for the purpose of the invention. For example, a rotating magnetic field may be provided by rotating a magnetic source around the alloy during annealing. Alternatively, the alloy may be made to rotate within a fixed magnetic field by being fixed to a suitable rotating support during annealing. Alternatively, a magnetic field of alternating magnitude (i.e. the size of the applied field may be changing with time) may be applied in multiple fixed orientations across three dimensions relative to the sample material.

The magnetic field may change in orientation or magnitude relative to the alloy at any rate suitable to randomise magnetically induced anisotropy within the alloy. In some embodiments, the rate at which the orientation or magnitude of the magnetic field is changed is at least about 1 Hz, at least about 30 Hz, at least about 100 Hz, at least about 300 Hz, at least about 1,000 Hz, or at least about 3,000 Hz. For example, the rate at which the orientation or magnitude of the magnetic field is changed is at from about 1,000 Hz to about 3,000 Hz.

In some embodiments, the magnetic field is a transverse magnetic field. In that regard, FIG. 1 shows a magnetic hysteresis curve measured on an embodiment alloys (Fe_{0.8}Co_{0.2})₈₇B₁₃ rapid annealed to 490° C. in 0.5 s. The curves refer to a sample alloy that underwent field annealing in the presence of a transverse magnetic field (TFA curve), compared to the hysteresis curve of a corresponding sample annealed in the absence of a magnetic field (NFA curve).

In some embodiments, the magnetic field is a longitudinal magnetic field. In those instances, the magnetic field is such that magnetic lines of force run substantially parallel to a main axis of the alloy. In these embodiments, the alloy sample may be referred to as a longitudinal field annealed (LFA) sample.

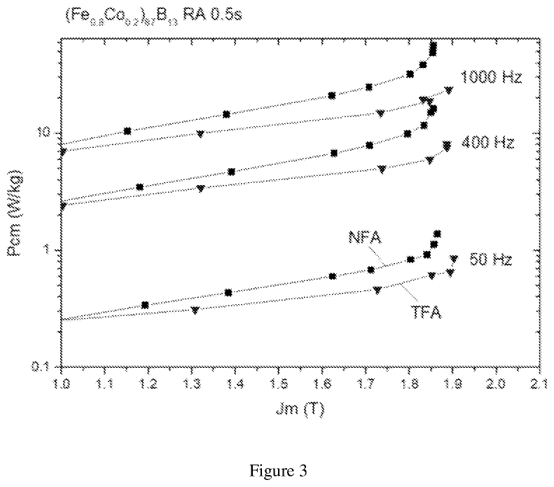

A further advantage of heating the amorphous alloy in the presence of a magnetic field is that the resulting alloy can show lower core losses relative to a corresponding alloy annealed in the absence of an applied magnetic field. In that regard, FIG. 3 shows core losses at 50 Hz, 400 Hz and 1,000 Hz of a (Fe_{0.8}Co_{0.2})₈₇B₁₃ alloy rapid annealed to 490° C. in 0.5 s in presence of an applied magnetic field (TFA data) and in the absence of one (NFA data). The lower magnetic core losses observed in the TFA sample are believed to be indicative of the lower magnetic permeability (i.e. the gradient of the curve in the region between 0 A/m and 400 A/m in FIG. 1) which reduces the formation of eddy currents within the TFA sample.

Following heating, the alloy may then be cooled. Cooling may be achieved by any means known to the skilled person. For example, cooling may be achieved by natural convection or forced convection. In some embodiments, the alloy is cooled by exposure to ambient conditions, such that it naturally cools to room temperature. In some embodiments, the alloy is cooled by placing it in thermal contact with a colder surface or element. For example, the alloy may be placed in thermal contact with a chilled block, a cold liquid bath, or a stream of cold air. A skilled person would be capable to devise suitable cooling procedures in that regard.

Typically, cooling may be at any cooling rate conducive to maintaining the crystalline structure of the alloy obtained during heating. For example, the alloy may be cooled at cooling rates of at least about 1° C./s, at least about 10° C./s, at least about 50° C./s, or at least about 100° C./s. In some embodiments, the alloy is cooled at a cooling rate of at least about 100° C./s. A skilled person would be aware of how to monitor the cooling rate in accordance to procedures described herein in relation to the heating rate.

In some embodiments, after being heated the alloy is cooled in the presence of a magnetic field of the kind described herein. For example, after being heated the alloy is cooled, for example to room temperature, in the presence of the same magnetic field used during the heating step. Advantageously, it was observed that when the alloy is cooled in the presence of a magnetic field the magnetic softness characteristics of the alloy can be further improved.

As used herein, “room temperature” refers to ambient temperatures that may be, for example, between 10° C. to 40° C., but is more typically between 15° C. to 30° C. For example, room temperature may be a temperature between 20° C. and 25° C.

Certain compositional features of the alloy can play a role in the crystallisation dynamics of the alloy during heating. For example, presence of Cu in the alloy may be effective to reduce the average grain size of the alloy. Without wanting to be confined by theory, it is understood that the Cu acts as a heterogeneous nucleation site during the heating of the amorphous alloy. Specifically, the addition of Cu to Fe-based nanocrystalline soft magnetic alloys may result in the formation of Cu-rich clusters prior to the onset of crystallization. These Cu rich clusters can act as heterogeneous nucleation sites which aid in grain refinement. Also, an increase in the Cu content is believed to reduce the Cu clustering onset temperature, resulting in improved grain refinement due to an increase in the number density of Cu clusters prior to the onset of crystallization. In general, low concentrations of copper (e.g. z=0.2, or z=0.5) can have significant effect on grain refinement of the crystalline phase, while an excessive amount of copper (e.g. above 1%) may result in the alloy being too brittle for use in practical applications, or prevent formation of an amorphous phase in the first place.

Accordingly, in some embodiments z is in the range of 0.2-1, 0.2-0.7, or 0.2-0.5. The alloy of the invention may also comprise an element M selected from Nb, Mo, Ta, W, Ni, and Sn. Specifically, the alloy comprises 0% to 8% atomic percent of Nb, Mo, Ta, W, Ni, or Sn (i.e. a=0-8). The role of the additional element M has been found to be relevant for grain refinement and/or stabilisation of the amorphous matrix phase during heating of the amorphous alloy. As a result, presence of element M can be advantageous to minimise the H_{c} of the alloy. For example, any one of those elements during synthesis of the alloy can inhibit grain growth of the crystalline phase, resulting in an alloy with reduced H_{c}. In addition, presence of element M can ensures further stabilisation of the amorphous matrix phase over a wider range of temperatures relative to the alloy absent M. On the other hand, excess content of element M in the alloy above 8% may be detrimental to the Jₛ, of the alloy due to the corresponding decrease in Fe and Co content in the alloy. Accordingly, in some embodiments a is in the range of 0-7.5, 0-5, 0-2.5, or 0-1. In some embodiments, z and a are both 0.

### EXAMPLES

### Example 1

Precursor amorphous ribbons with a nominal composition of (Fe₁₋ₓCoₓ)₈₇B₁₃ where x=0 to 0.5 were produced by melt spinning (planar flow casting method) in an Ar atmosphere. Ribbons having thickness of approximately 10 to 15 μm and a width of 1 to 12 mm were obtained. Ultra-rapid annealing was conducted in an Ar atmosphere with ribbons placed inside 20 μm thickness Cu foil packets. These packers were then compressed between two pre-heated Cu blocks (150 mm long, 50 mm wide) for 0.5 s with a force of 950 N using a pneumatic cylinder and an automated timing mechanism.

Average grain size (D) was estimated by X-ray diffraction (XRD) with a Co K_{α} source using Scherrer's formula. Density was estimated using a He gas pycnometer. The saturation magnetic polarization (Jₛ=μ₀Mₛ) was estimated at 0.8 MAm and at 22° C. (295 K) using a Riken BHV-35H vibrating sample magnetometer (VSM). The H_{c} estimations were made at 295 K using a Riken Denshi BHS-40 DC hysteresis loop tracer.

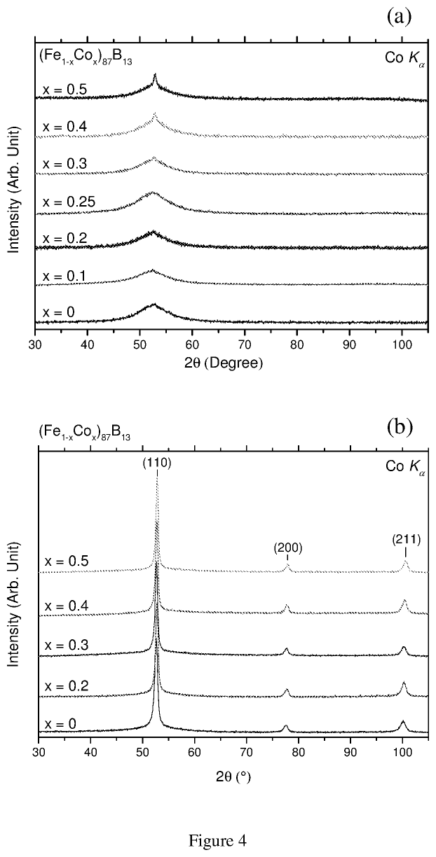

FIG. 4(a) displays XRD patters acquired from a selection of as-cast amorphous ribbons with the composition (Fe₁₋ₓCoₓ)₈₇B₁₃. The patterns were acquired from the side of the ribbon which did not come into contact with the casting wheel. No discernible crystallization reflection peaks are visible for x=0 to 0.3 and so these ribbons are considered amorphous over length scales detectable by XRD. A crystallization reflection peak identified as bcc Fe is visible at approximately 52.8° for x=0.4 and 0.5. However, the low intensity of this crystallization reflection peak relative to the broad amorphous background suggests that the volume fraction of bcc Fe in the as-cast state is below 20%. FIG. 4(b) displays XRD patterns that were acquired after an ultra-rapid annealing process. The patterns display crystallisation reflection peaks identified as belonging to bcc Fe.

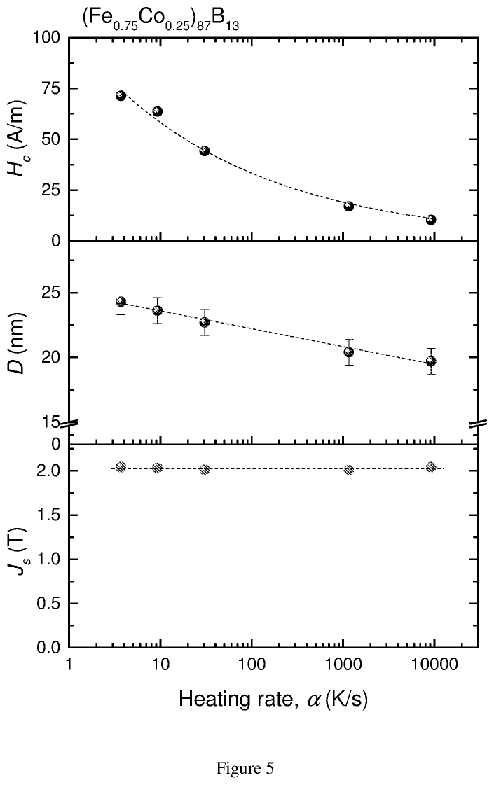

FIG. 5 displays H_{c}, D as determined by XRD, and Jₛ for (Fe_{0.75}Co_{0.25})₈₇B₁₃ with respect to the heating rate (α). For each heating rate used the annealing time was selected so as to give the minimum after the onset of primary crystallization. The heating rate was modified by placing insulating material between the sample and the pre-heated copper blocks. H_{c} is seen to decrease from approximately 70 A/m to 10 A/m with an increase in the heating rate from 3.7 to approximately 10,000° C./s while Jₛ remains greater than 2 T for all conditions. The reduction in seen in FIG. 5 is believed to be linked to the corresponding reduction in D from 24.3 to 19.7 nm and demonstrates that an ultra-rapid annealing process can be utilized in order to maximize magnetic softness in this alloy system.

The data of FIG. 5 confirms that coercivity and grain size decrease as the heating rate increases. Based on the trend lines (dashed lines) shown in the plots of FIG. 5, it is possible to appreciate that a heating rate of 200° C./s or above is advantageous to achieve a grain size of less than 30 nm (22 nm or less in this Example). This in turn corresponds to a coercivity (H_{c}) of 25 A/m or less, while the magnetization saturation (Jₛ) can be maintained above 1.98 T. As discussed herein, a low coercivity of 25 A/m or less would be typically required for commercial applications. Overall, the data confirm the significant advantages offered by heating the alloy at a rate of 200° C./s or above.

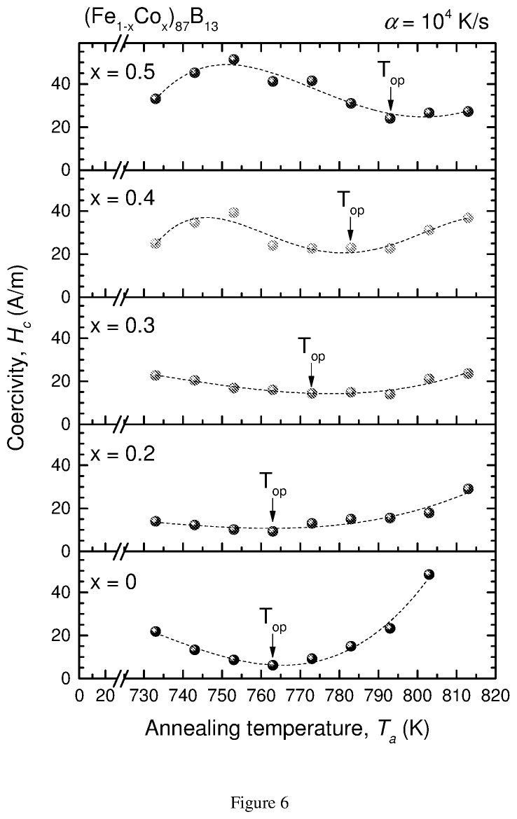

FIG. 6 displays with respect to annealing temperature (Ta) for select alloy compositions which were all annealed at the highest heating rate of approximately 10,000° C./s with a holding time of 0.5 s. The optimum annealing temperature (Tₒₚ) can be identified as the point where the minimum coercivity is reached for each alloy. Tₒₚ is seen be in the vicinity of about 490° C. (763 K) for x=0 and 0.2 and about 500° C. (773 K), about 510° C. (783 K) and about 520° C. (793 K) for x=0.3, 0.4 and 0.5 respectively.

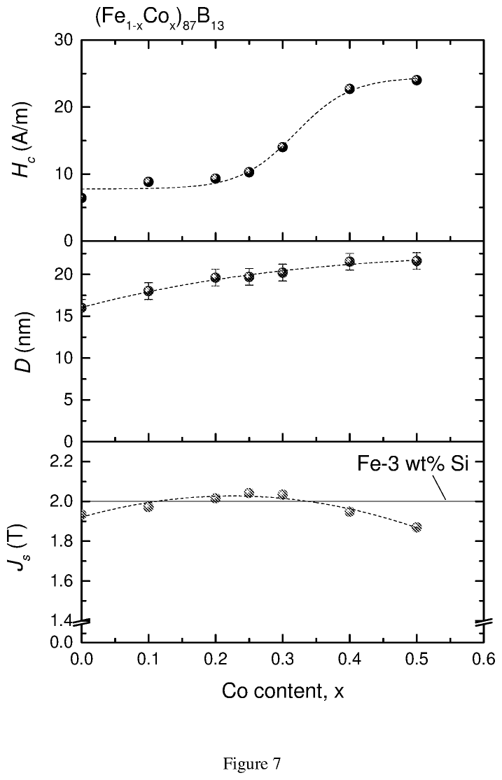

The H_{c} D and Jₛ for (Fe₁₋ₓCoₓ)₈₇B₁₃ after annealing at Tₒₚ with a heating rate of approximately 10,000° C./s and a hold time of 0.5 s is shown in FIG. 7. For x values (relative to Co content) of less than 0.25 only a moderate increase in is seen, with 6.4 A/m for x=0 and 10.2 A/m for x=0.25. For a Co content greater than 0.25 an abrupt increase in is observed with a peak of 24 A/m for x=0.5. This increase in with Co content can be partially attributed to a coarsening of the microstructure as D is raised by approximately 1.3 nm for every x=0.1 increase. However, the abrupt increase in H_{c} above x=0.25 is not reflected by the gradual change in D seen in FIG. 7. The addition of Co is also seen to increase Jₛ with a maximum of 2.04 T being observed for x=0.25 which is directly comparable to Fe-3 wt % Si with a measured value of 2.0 T.

### Example 2

The effect of Cu addition on nanocrystalline (Fe_{0.8}Co_{0.2})_{87-z}B₁₃Cu_{z} where z=0 to 1.5 is also investigated. In this context, samples in which z=1.5 have been made for comparison purposes. Precursor amorphous ribbons with a nominal composition of (Fe_{0.8}Co_{0.2})_{87-z}B₁₃Cu_{z} and (Fe₁₋ₓCoₓ)₈₆B₁₃Cu₁ where z=0 to 1.5 (the sample with z=1.5 being for comparison) and x=0 to 0.3 were produced by melt spinning (planar flow casting method) in an Ar atmosphere. A ribbon thicknesses of approximately 10 to 15 μm and a width of 1 to 12 mm was obtained. Ultra-rapid annealing was conducted in an Ar atmosphere with ribbons placed inside 20 μm thickness Cu foil packets. These packers were then compressed between two pre-heated Cu blocks (150 mm long, 50 mm wide) for 0.5 s with a force of 950 N using a pneumatic cylinder and an automated timing mechanism.

Grain size was estimated by X-ray diffraction (XRD) with a Co K_{α} source using Scherrer's formula. Density values reported in this study were estimated using a He gas pycnometer. The saturation magnetic polarization (Jₛ=μ₀Mₛ) was estimated at 0.8 MAm and at 295 K using a Riken BHV-35H vibrating sample magnetometer (VSM). The H_{c} estimations were made at 295 K using a Riken Denshi BHS-40 DC hysteresis loop tracer.

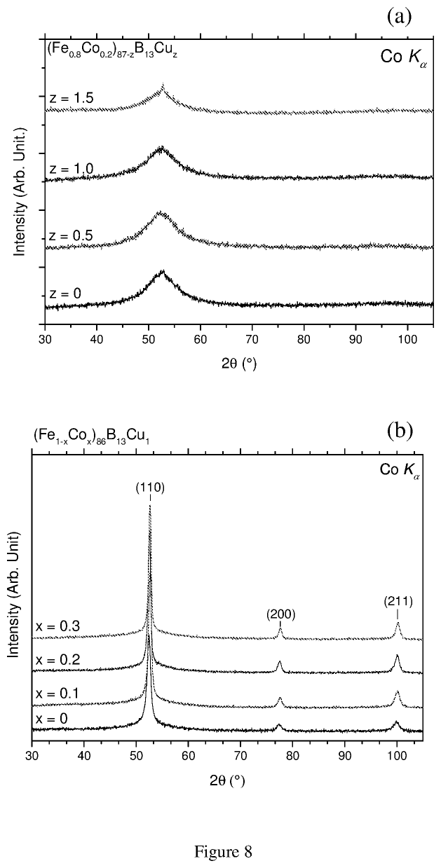

FIG. 8(a) show XRD patterns of as quenched (i.e. before annealing) amorphous (Fe_{0.8}Co_{0.2})_{87-z}B₁₃Cu_{z} samples with z=0, 0.5, 1, 1.5 (the latter being for comparison). FIG. 8(b) show XRD patterns measured on annealed (Fe₁₋ₓCoₓ)₈₆B₁₃Cu₁ with x=0 to 0.3.

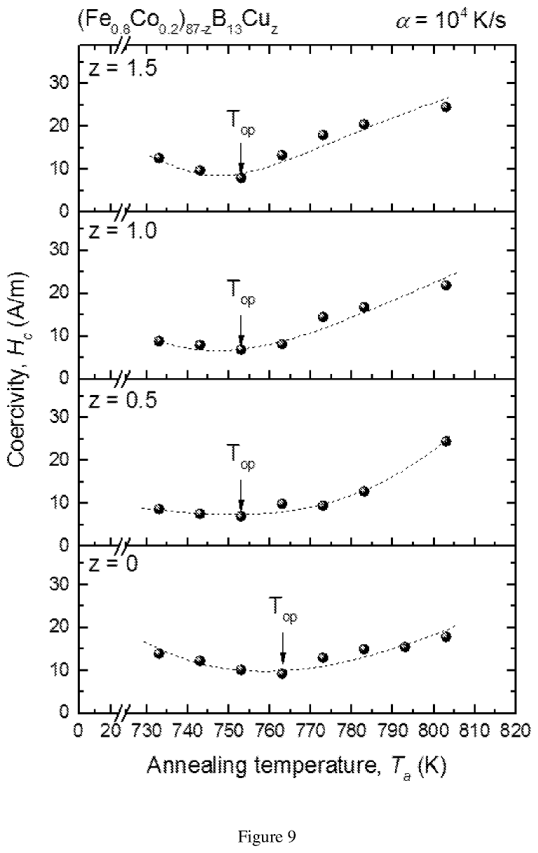

FIG. 9 displays with respect to Tₐ for (Fe_{0.8}Co_{0.2})_{87-z}B₁₃Cu_{z} where z=0, 0.5, 1 and 1.5 (the latter being for comparison). When as-cast ribbons of these compositions were examined by XRD (see FIG. 8) no discernable crystallization reflection peaks were visible for alloy with z=0-1 (e.g. z=0.5 and 1.0). In those cases, the data shows a broad reflection indicative of amorphous alloy phase. However, some degree of crystallization was observed for alloy with z=1.5. It can be seen from FIG. 9 that Tₒₚ is lowered by approximately 10° C. by the addition of Cu while becomes more sensitive to changes in the annealing temperature. When considering the general trend of the coercivity data in the plots of FIG. 9, it is possible to observe that as the amount of Cu decreases from 1% to 0% (i.e. from z=1 to z=0) the window of annealing temperatures affording very low coercivity (i.e. below 15 A/m) progressively expands. Overall, relative to alloys with Cu content above 1% (e.g. 1.5%), those in which z=0-1 offer a wider window of annealing temperatures which may be adopted to obtain an advantageous combination of very high magnetic saturation and very low coercivity.

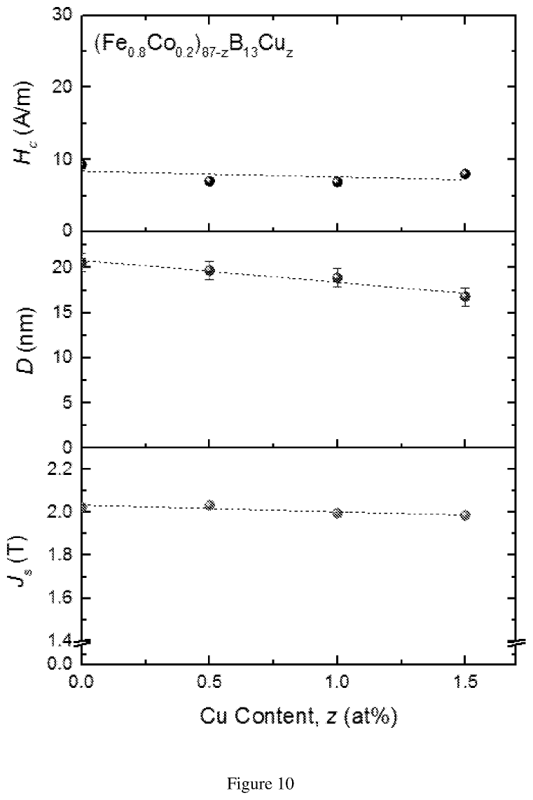

FIG. 10 displays D, and Jₛ with respect to Cu content for (Fe_{0.8}Co_{0.2})_{87-z}B₁₃Cu_{z} annealed at Tₒₚ with a heating rate of approximately 10,000° C./s and a hold time of 0.5 s. The only phase identified in the annealed samples by XRD was that belonging to bcc Fe. D decreases by the addition of Cu, with z=0 and z=1.5 showing average grain size of 20.6 to 16.8 nm respectively.

It is seen from FIG. 10 that decreases from 9.3 to 6.9 A/m by the addition of 0.5 at % Cu and that further increasing the Cu content maintains H_{c} below 10 A/m. Overall, the data of FIG. 10 confirms that when the Cu (z) content increases from z=0 to z=1.0, the coercivity advantageously drops (i.e. by about 2.4 A/m from 9.3 to 6.9 A/m, respectively). However, as the amount of Cu (z) exceeds 1% (i.e. z above 1) the coercivity starts to increase (up to 8 A/m for z=1.5).

Turning to the saturation magnetisation (Jₛ) data in FIG. 10, its value is also overserved to drop slightly as the amount of Cu increases, with an average reduction of approximately 0.01 T per at % Cu. Despite the slight drop in Jₛ, the data indicates that alloys with Jₛ above 1.98 T, for example 2T or even above, can be obtained by controlling the amount of Cu to 1% or less. This further reinforces the discussion made herein in relation to controlling the amount of Cu to be less than 1%. In that regard, it is also recommended to limit the amount of Cu to 1% or below (i.e. z=0-1) to ensure adequate mechanical characteristics of the alloy and formation of an amorphous phase. This becomes particularly relevant when the alloy is produced in ribbon form, in which case the poor mechanical characteristics of alloy with z above 1 (i.e. Cu content above 1%) can preclude formation of ribbons with a thickness significantly below 20 μm, for example below 15 μm.

The addition of Co increases the Cu clustering onset temperature (T_{clust}). For example, when 20% of Fe is replaced with Co, T_{clust} increases to a value equal to that of the crystallization onset temperature. As Cu clustering must occur prior to the onset of significant crystallization in order to aid in grain refinement, the replacement of Fe with Co can decrease the effectiveness of Cu as a nucleating agent. An increase in the Cu content may also reduce the Cu clustering onset temperature, resulting in improved grain refinement due to an increase in the number density of Cu clusters prior to the onset of crystallization.

The data shown herein shows a clear decrease in grain size with the addition of Cu to (Fe_{0.8}Co_{0.2})₈₇B₁₃. Based on the trend observed in FIG. 10, even a minor addition of 0.5 at % Cu may be effective for grain refinement. This may suggest that the T_{clust} onset temperature is below that of the crystallization onset temperature in this alloy system for even minor Cu additions when rapidly annealed at Tₒₚ. This effect may possibly be due to the relatively high annealing temperatures made possible by the ultra-rapid annealing technique. Furthermore, the reduction in D with the addition of more Cu may suggest that the number density of Cu clusters is increased prior to the onset of crystallization.

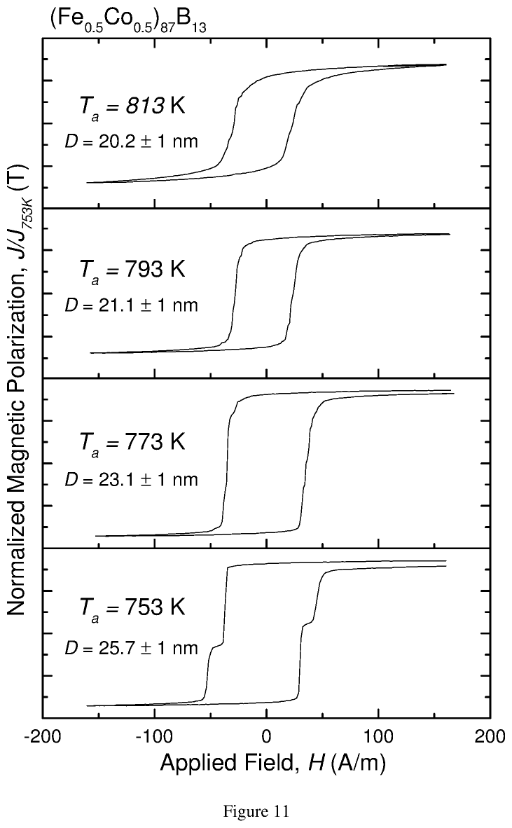

The data therefore supports the notion that, in a general sense, Cu is effective at reducing the mean grain size and provides some improvement in the magnetic softness characteristics of the sample alloy. Care should nevertheless be taken with regard to ensuring that the amount of Cu does not compromise the mechanical stability of the alloy, or the formation of the amorphous phase. In that regard, and as discussed herein, it is recommended to limit the amount of Cu to 1% or below (i.e. z=0-1) to ensure adequate mechanical characteristics of the alloy and formation of an amorphous phase. The data also indicates that any disconnection between grain size and magnetic softness may be due to the formation of sizeable magnetization induced anisotropy upon the addition of Co which is detrimental to the exchange softening process, as shown in FIG. 11.

FIG. 11 shows DC BH hysteresis curves and listed grain sizes for (Fe_{0.5}Co_{0.5})₈₇B₁₃ after ultra-rapidly annealing at 460° C. (733 K) to 540° C. (813 K) for 0.5 s. The samples used to produce the BH curves in FIG. 4 were approximately 100 mm long and 1 mm wide and were measured using an open magnetic path in a 0.5 m long solenoid with an air-core compensated pickup coil. D has also been estimated and is also listed in FIG. 4. It is clear that D is reduced as the annealing temperature is raised. This improvement in the grain refinement with annealing temperature is a likely cause for the reduction in H_{c} seen. However, it can also be seen from FIG. 4 that the BH curve for the sample annealed at 480° C. (753 K) displays clear indications of Barkhausen jumps. This, in combination with a highly square BH curve (high remanence to saturation ratio), suggest that a significant induced anisotropy may be present in this material. Furthermore, it can also be seen that there is no indication of Barkhausen jumps for sample annealed above 480° C. (753 K) and the square-ness of the BH.

### Example 3

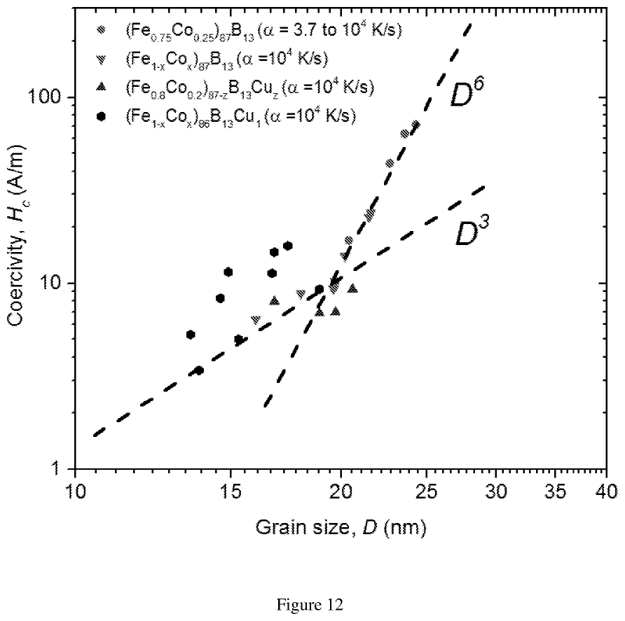

FIG. 12 displays the relationship between and D for (Fe₁₋ₓCoₓ)₈₇B₁₃, (Fe_{0.8}Co_{0.2})_{87-z}B₁₃Cu_{z} and (Fe₁₋ₓCoₓ)₈₆B₁₃Cu₁ annealed at a heating rate of 10,000° C./s. Also included is H_{c} and D from FIG. 5 from (Fe_{0.75}Co_{0.25})₈₇B₁₃ which was annealed at heating rates ranging from 3.7 to 10,000° C./s.

For grain sizes greater than 20 nm the coercivity is well described by a D⁶ dependence while for smaller grain sizes this dependence is closer to D³. Both the D⁶ and D³ dependence is predicted by Herzer's random anisotropy mode. A D³ dependence has been shown to occur when the exchange length is controlled by induced anisotropies which are coherent over length scales greater than the exchange length. It is therefore believed that magnetization induced anisotropies (Kᵤ) scale with the square of Co content for the tested samples. This further supports the notion that the relative insensitivity of to changes in D for (Fe_{0.8}Co_{0.2})₈₇₋ₓB₁₃Cu_{z} is due to the presence of a sizeable Kᵤ in these materials.

Furthermore, it can also been seen from FIG. 12 that there is considerable scattering of the data in the D³ region below approximately 20 nm. This scattering can be understood as a reflection of the different levels of Kᵤ present in each composition. The switchover from a D⁶ to a D³ grain size dependence of is known to occur when the ratio of the random magnetocrystalline anisotropy to Kᵤ is approximately 1:2. Therefore, as Kᵤ varies by approximately one order of magnitude between compositions in FIG. 12 it is expected that the switchover in grain size dependence will take place at different grain sizes, leading to the observed scattering in the data.

It was previously observed in FIG. 7 that for nanocrystalline (Fe₁₋ₓCoₓ)₈₇B₁₃ the H_{c} shows an abrupt increase at x=0.2 despite a gradual change in D. From FIG. 12 it can be seen that this increase in for (Fe₁₋ₓCoₓ)₈₇B₁₃ corresponds to a transition from a D⁶ to a D³ dependence. It is therefore suggested that the abrupt increase in observed at x=0.2 is due to an increase in Kᵤ brought about by the addition of Co. The randomization of magnetization induced anisotropies by rotating field annealing would therefore be effective at improving the magnetic softness of the tested samples.

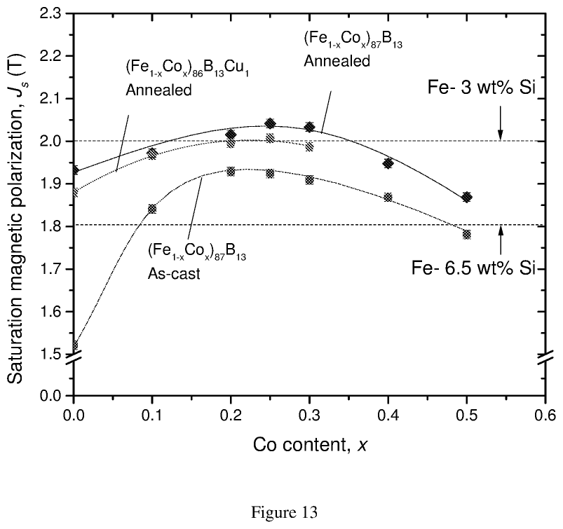

FIG. 13 displays the Jₛ of (Fe₁₋ₓCoₓ)₈₇B₁₃ in the as-cast and nanocrystalline state and (Fe₁₋ₓCoₓ)₈₆B₁₃Cu₁ in the nanocrystalline state. Also shown are common values for the Jₛ of non-oriented Fe—Si steel with 3 and 6.5 wt % Si. It is seen that for nanocrystalline (Fe₁₋ₓCoₓ)₈₇B₁₃ with x=0.2, 0.25 and 0.3 a Jₛ in excess of 2 T is reached, which is directly comparable to that of Fe-3 wt % Si steel.

The largest single increase in Jₛ is observed in the as-cast state when a Co content of 0.1 is added to the Co free composition of Fe₈₇B₁₃. This increase in Jₛ of the as-cast ribbons can be attributed to an increase in the Curie temperature (T_{c}) brought about by the addition of Co, which increases from about 220° C. (497K) to a value greater than the primary crystallization onset temperature of about 370° C. (643K).

It is well established that the peak Jₛ of crystalline Fe—Co is located at a Co content of approximately x=0.35. However, for the as-cast and annealed (Fe₁₋ₓCoₓ)₈₇B₁₃ samples this peak is centered around x=0.2 and 0.25 respectively.

This difference in the peak Jₛ position can be understood as a reflection of the local volume weighted average contributions from the residual amorphous phase (Jₛ^{amo}) and crystalline phase (K) such that

Jₛ=V_{f}^{cry}Jₛ^{cry}+(1−V_{f}^{cry})Jₛ^{amo}

where V_{f}^{cry} is the crystalline volume fraction.

If it is assumed that Co is evenly portioned into both phases after nanocrystallization, then the equilibrium volume fraction of the crystalline phase can be estimated by mass balance.

Assuming that the composition of the residual amorphous phase after annealing is approaching that of Fe₃B then a crystalline volume fraction of approximately 50% is expected. Therefore, provided the B-rich residual amorphous phase and crystalline Fe—Co phase have a similar Co dependence of Jₛ to that of their bulk counterparts, then it is expected that a two-phase nanocrystalline material will have a peak Jₛ at a Co content which falls in-between that the amorphous (x=0.2) and Fe—Co crystalline (x=0.35) phases.

Table 1 provides a summary of H_{c}, Jₛ, and density (P) for rapidly annealed (Fe_{0.8}Co_{0.2})₈₇B₁₃ and (Fe_{0.8}Co_{0.2})₈₆B₁₃Cu₁, compared with corresponding characteristics of conventional soft magnetic materials. The comparison allows appreciating that the alloys of the invention can achieve a combination of high Jₛ (above 2 T) and low H_{c} (below 10 A/m) that is superior to conventional soft magnetic materials, including commercial HiB-nanoperm alloys, nanocrystalline Fe_{73.5} Cu₁Nb₃Si_{15.5}B₇ (Finemet), and Fe-based amorphous and non-oriented (NO) Fe—Si steels.

TABLE 1
Properties of the (Fe—Co)—B—(Cu) compositions investigated
in this study along with values from the literature for
nanocrystalline, amorphous and crystalline materials.

| | H_{c} (A/m) | Jₛ (T) | P (g/cm³) |
|---|---|---|---|
| (Fe_{0.8}Co_{0.2})₈₇B₁₃ | 9.3 ± 0.5 | 2.02 ± 0.01 | 7.68 ± 0.02 |
| (Fe_{0.8}Co_{0.2})₈₆B₁₃Cu₁ | 7.0 ± 0.5 | 2.00 ± 0.01 | 7.68 ± 0.02 |
| Fe₈₇B₁₃ [prior art] | 6.7 ± 0.5 | 1.92 ± 0.01 | 7.62 |
| Fe₈₅B₁₃Ni₂[prior art] | 3.8 ± 0.5 | 1.90 ± 0.01 | 7.62 |
| Fe₈₆B₁₃Cu₁ [prior art] | 3.5 ± 0.5 | 1.89 ± 0.1 | 7.63 |
| Fe₈₅Nb₁B₁₃Cu₁ [prior art] | 2.5 ± 0.5 | 1.82 ± 0.01 | 7.64 |
| Fe_{73.5}Cu₁Nb₃Si_{15.5}B₇ [prior art] | <1.0 ± 0.5 | 1.23 ± 0.01 | 7.35 |
| Fe-based Amo. [prior art] | 2.4 ± 0.5 | 1.56 ± 0.01 | 7.2 |
| NO Fe-3 wt % Si [prior art] | 55 ± 0.5 | 2.0-2.05 ± 0.01 | 7.64-7.76 |
| NO Fe-6.5 wt % Si [prior art] | 18.5 ± 0.5 | 1.80-1.85 ± 0.01 | 7.49 |

### Example 4

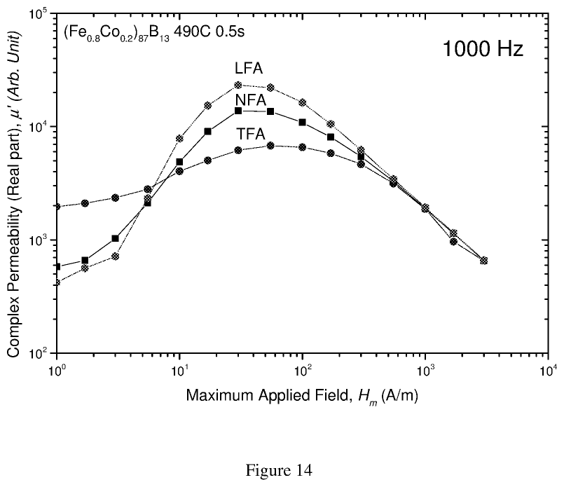

FIG. 14 displays the complex magnetic permeability with respect to applied magnetic field acquired at 1000 Hz (frequency of the field used during measurement) for a transverse field annealed (TFA) sample, a longitudinal field annealed (LFA) sample and a sample annealed without the application of an external applied field (NFA). The composition of the samples was (Fe_{0.8}Co_{0.2})₈₇B₁₃ and it was annealed at 490° C. for 0.5 s with a heating rate of 10,000° C./s (10,000 K/s) in all three conditions.

TFA was conducted by placing a sample between two pre-heated copper blocks in the presence of an approximately 24,000 A/m applied magnetic field oriented transverse to the measurement direction. LFA was conducted by placing a sample between two pre-heated copper blocks in the presence of an approximately 3,000 A/m applied magnetic field oriented longitudinally to the measurement direction.

The complex permeability is seen in FIG. 14 to be largest at approximately 40 A/m for all three annealing methods. The LFA sample is seen to have the highest peak value of complex permeability, at approximately 30,000, and the TFA sample is seen to have the lowest peak value at approximately 7,000. This reduction in the complex permeability for the TFA sample is attributed to the formation of a directional magnetization induced anisotropy. This directional magnetization induced anisotropy is perpendicular to the measurement direction for the TFA sample and so it acts to reduce the complex permeability relative to the NFA sample. The LFA sample has the opposite effect, with a magnetization induced anisotropy being induced in parallel to the measurement direction, increasing the relative complex permeability of the sample.

It is well established that a high magnetic permeability is associated with a rapid rearrangement of magnetic domains within a soft magnetic material. This rapid change in domain structure is also well known to be associated with larger eddy current formation than a domain structure that slowly rotates, as is typical for materials with a low magnetic permeability. Therefore, the reduction in core losses seen for a TFA sample with respect to a NFA sample in FIG. 3 and in Table 2 is a result of reduced eddy current losses due to a reduction in the magnetic permeability of the material made possible by a transverse field annealing process.

From Table 2 it can also be seen that the core losses are considerably lower for the rapidly annealed (Fe_{0.8}Co_{0.2})₈₇B₁₃ samples when compared to Fe-3 wt % Si steel regardless of if an applied field is used or not.

TABLE 2
AC core loss for rapidly annealed (Fe_{0.8}Co_{0.2})₈₇B₁₃
at 50, 400 and 1000 Hz with a maximum magnetisation of 1.5 T

| | 1.5 T, | 1.5 T, | 1.5 T, |
|---|---|---|---|
| | 50 Hz | 400 Hz | 1000 Hz |
| NFA | 0.54 | 5.8 | 18.0 |
| TFA | 0.38 | 4.1 | 11.9 |
| Fe-3 wt % Si [Prior art] | 2.99 | 45.6 | 202 |

### Example 5

The effect of M addition on nanocrystalline (Fe₁₋ₓCoₓ)_{87-y-a-z}B_{y}Cu_{z}Mₐ where x=0.1 to 0.4, y=13 to 14, z=0 to 1 and a=0 to 8 was also investigated. Precursor amorphous ribbons with a nominal composition equal to those listed in Table 3 below were produced by melt spinning (planar flow casting method) in an Ar atmosphere.

Ribbons with thickness of approximately 10 to 15 μm and a width of 1 to 12 mm were obtained. Ultra-rapid annealing was conducted in an Ar atmosphere with ribbons placed inside 20 μm thickness Cu foil packets. These packers were then compressed between two pre-heated Cu blocks (150 mm long, 50 mm wide) for 0.5 s with a force of 950 N using a pneumatic cylinder and an automated timing mechanism.

XRD with a Co K_{α} source was used to confirm the formation of an amorphous phase after the casting process with a volume fraction of at least 80%. XRD was also used to confirm the formation of a bcc Fe—Co or Fe—Co—Ni, when Ni is present, crystalline phase embedded within a residual amorphous phase. The saturation magnetic polarization (Jₛ=μ₀Mₛ) was estimated at 0.8 MA/m and at 295 K using a Riken BHV-35H vibrating sample magnetometer (VSM). The H_{c} estimations were made at 295 K using a Riken Denshi BHS-40 DC hysteresis loop tracer.

Table 3 displays the H_{c} and Jₛ for a range of rapidly annealed nanocrystalline magnetically soft materials with compositions of (Fe₁₋ₓCoₓ)_{100-y-a-z}B_{y}Cu_{z}Mₐ.

TABLE 3
Properties of (Fe₁₋ₓCoₓ)_{100-y-a-z}B_{y}Cu_{z}Mₐ, where M = Nb, Mo,
Ta, W, Ni, or Sn compositions investigated in this study.

| | Hc (A/m) | Js (T) |
|---|---|---|
| (Fe_{0.9}Co_{0.1})₈₆B₁₄ | 11.7 | 1.95 |
| (Fe_{0.8}Co_{0.2})₈₆B₁₄ | 11.0 | 2.03 |
| (Fe_{0.7}Co_{0.3})₈₆B₁₄ | 14.8 | 1.97 |
| (Fe_{0.6}Co_{0.4})₈₆B₁₄ | 31.6 | 1.90 |
| (Fe_{0.8}Co_{0.2})₈₅B₁₄Cu₁ | 9.4 | 2.00 |
| (Fe_{0.7}Co_{0.3})₈₅B₁₄Cu₁ | 12.4 | 1.98 |
| (Fe_{0.8}Co_{0.2})₈₆B₁₃Nb₁ | 7.1 | 1.93 |
| (Fe_{0.8}Co_{0.2})₈₃B₁₃Nb₄ | 12.0 | 1.77 |
| (Fe_{0.8}Co_{0.2})_{86.5}B₁₃Mo_{0.5} | 14.8 | 1.96 |
| (Fe_{0.8}Co_{0.2})₈₅B₁₃Mo₂ | 4.2 | 1.81 |
| (Fe_{0.8}Co_{0.2})₈₆B₁₃Ta₁ | 9.0 | 1.94 |
| (Fe_{0.8}Co_{0.2})₈₅B₁₃Ta₂ | 7.8 | 1.86 |
| (Fe_{0.8}Co_{0.2})₈₆B₁₃W₁ | 11.8 | 1.94 |
| (Fe_{0.8}Co_{0.2})₈₂B₁₃Ni₅ | 4.4 | 1.92 |
| (Fe_{0.8}Co_{0.2})₇₉B₁₃Ni₈ | 5.2 | 1.88 |
| (Fe_{0.9}Co_{0.1})₈₁B₁₄Ni₅ | 4.3 | 1.90 |
| (Fe_{0.9}Co_{0.1})₇₈B₁₄Ni₈ | 3.2 | 1.85 |
| (Fe_{0.8}Co_{0.2})₈₁B₁₄Ni₅ | 5.4 | 1.91 |
| ((Fe_{0.8}Co_{0.2})₇₈B₁₄Ni₈ | 6.3 | 1.82 |
| (Fe_{0.8}Co_{0.2})₈₆B₁₃Sn₁ | 40.0 | 1.92 |
| (Fe_{0.8}Co_{0.2})₈₄B₁₃Sn₃ | 22.7 | 1.79 |

The addition of M elements is primarily to improve glass formability but is also observed to decrease H_{c} in some composition. However, the addition of all M elements is also seen to reduce Jₛ. This is also seen to be the case for the addition of y and z elements, which substitute ferromagnetic Fe and Co.

### Example 6

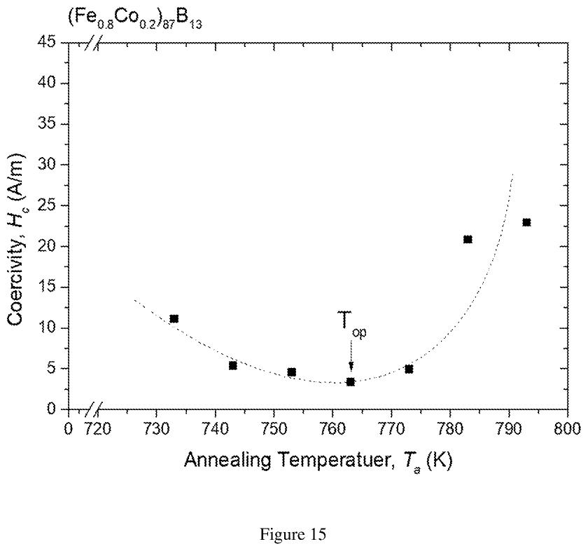

Additional magnetic characterisation of (Fe_{0.8}Co_{0.2})₈₇B₁₃ samples is shown in FIGS. 15-17.

FIG. 15 shows the coercivity in relation to the annealing temperature measured on (Fe_{0.8}Co_{0.2})₈₇B₁₃ samples. The samples were rapidly annealed by being clamped between pre-heated copper blocks for 0.5 s. The Figure also shows an optimum annealing temperature (Tₒₚ) at about 763K (i.e. 490° C.) for minimum coercivity of 3.4 A/m.

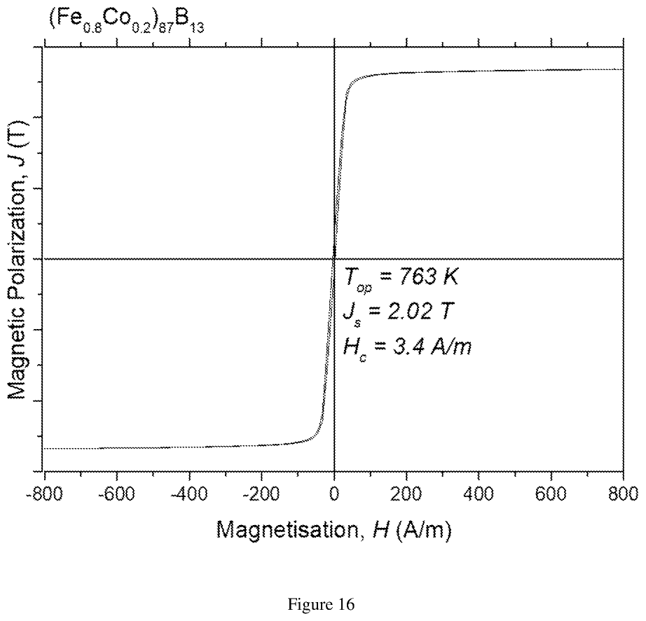

FIG. 16 shows direct current (DC) hysterics loop measured for the (Fe_{0.8}Co_{0.2})₈₇B₁₃ sample obtained at the optimum annealing temperature. A coercivity of 3.4 A/m is observed. Independent measurement by VSM determined that the sample provides a saturation polarisation of 2.02 T.

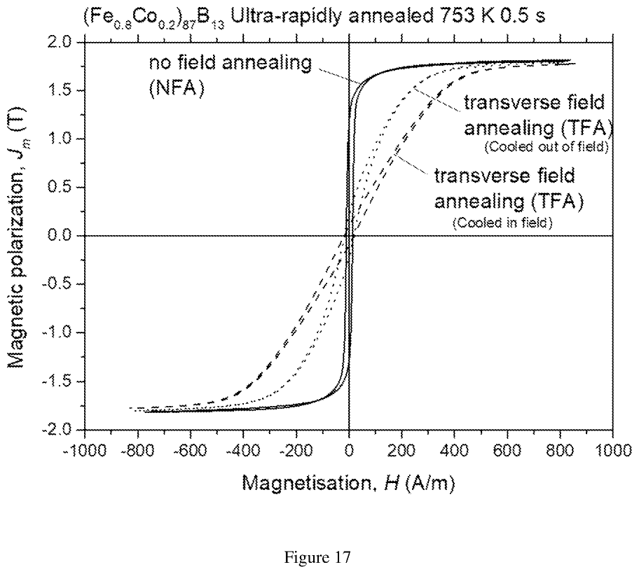

FIG. 17 shows the effect of rapidly annealing a (Fe_{0.8}Co_{0.2})₈₇B₁₃ in the presence of an applied transverse field, in which subsequent cooling was performed either in the presence or in the absence of the applied magnetic field. The Figure allows appreciating the impact of magnetic field annealing on the shape of a DC hysteresis loop for the (Fe_{0.8}Co_{0.2})₈₇B₁₃ after rapid annealing at 753 K (i.e. 480° C.) using pre-heated copper blocks. It can be seen that cooling the ribbon post-annealing outside of the influence of a magnetic field reduces the effectiveness of the field annealing method when compared to cooling the ribbon within the influence of a magnetic field. Therefore, for optimum magnetic properties, when field annealing is utilised the magnetic field should be present for all stages of annealing. Relevant parameters are outlined in the Table below.

TABLE 4
Relevant parameters of data shown in FIG. 17.

| | | TFA (cooled in | TFA (cooled out |
|---|---|---|---|
| | NFA | field, CIF) | of field, COF) |
| Hc (T) | 12 | 18.2 | 18 |
| Jr (T) | 1.22 | 0.1 | 0.22 |
| Jr/Js | 0.61 | 0.05 | 0.1 |
| Hk (A/m) | — | 361 | 200 |
| Ku (J/m³) | — | 310 | 173 |

### Example 7

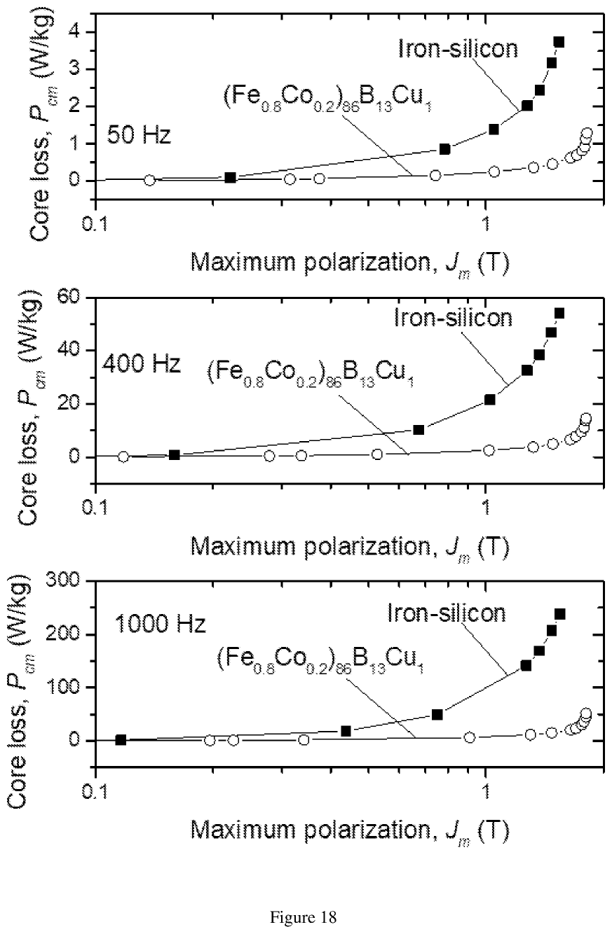

Magnetic characterisation of (Fe_{0.8}Co_{0.2})₈₆B₁₃Cu₁ samples is shown in FIG. 18. In particular, the data relates to core loss measured at 50, 400 and 1000 Hz for a 3 wt % iron-silicon steel compared with a rapidly annealed (Fe_{0.8}Co_{0.2})₈₆B₁₃Cu₁ sample in accordance with an embodiment of the invention. The data allows appreciating that for all tested frequencies and magnetisation levels the core loss of (Fe_{0.8}Co_{0.2})₈₆B₁₃Cu₁ is significantly lower than that of iron-silicon steel.

Throughout this specification and the claims which follow, unless the context requires otherwise, the word ‘comprise’, and variations such as ‘comprises’ and ‘comprising’, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1. An alloy having formula (Fe₁₋ₓCoₓ)_{100-y-z-a}B_{y}Cu_{z}Mₐ, in which:
x=0.1-0.4,
y=10-16,
z=0-1,
a=0-8, and
M=Nb, Mo, Ta, W, Ni, or Sn,
wherein the alloy has crystalline grains with an average size of 30 nm or less.

2. The alloy of claim 1, wherein x is in the range of from about 0.2 to about 0.3.

3. The alloy of claim 1, wherein z is in the range of from about 0.2 to 1.

4. The alloy of claim 1, wherein z and a are both 0.

5. The alloy of claim 1, having a magnetization saturation (Jₛ) of at least 2 T.

6. The alloy of claim 1, wherein the crystalline grains have an average size of from 10 nm to 30 nm.

7. A method of making an alloy, the method comprising:
preparing an amorphous alloy having formula (Fe₁₋ₓCoₓ)_{100-y-z-a}B_{y}Cu_{z}Mₐ, in which
x=0.1-0.4,
y=10-16,
z=0-1,
a=0-8, and
M=Nb, Mo, Ta, W, Ni, or Sn, and
heating the amorphous alloy at a heating rate of at least 200° C./s.

8. The method of claim 7, wherein the heating of the amorphous alloy comprises exposing the alloy to a magnetic field.

9. The method of claim 7, wherein the step of heating the amorphous alloy comprises exposing the alloy to a rotating magnetic field in the range of at least 0.3 kA/m.

10. The method of claim 7, wherein the step of heating the amorphous alloy comprises exposing the alloy to a magnetic field that changes its orientation and/or magnitude in the range of from about 1 Hz to about 3,000 Hz.

11. The method of claim 8, wherein following heating the alloy is cooled in the presence of the magnetic field.

12. The method of claim 7, wherein the amorphous alloy is heated to an annealing temperature in the range of from about 350° C. to about 650° C.

13. The method of claim 7, wherein the amorphous alloy is heated at a predetermined annealing temperature, and held at the annealing temperature for about 0 to about 80 seconds.

14. The method of claim 7, wherein the amorphous alloy is in the form of a ribbon having thickness in the range of from about 5 μm to about 15 μm.

15. The method of claim 7, wherein heating the amorphous alloy is performed by clamping the alloy with a pressure of at least about 3 kPa between pre-heated blocks.

16. The method of claim 7, wherein heating the amorphous alloy is performed by passing the alloy between pre-heated rolls.

17. The method of claim 7, comprising heating the amorphous alloy at a heating rate of at least 1,000° C./s.
